(19) United States
(12) Patent Application Publication
(10) Pub. No.: US 2025/0083318 A1
(43) Pub. Date: Mar. 13, 2025

(54) CONTROL SYSTEM, CONTROL METHOD, AND NON-TRANSITORY COMPUTER-READABLE MEDIUM

(71) Applicants: Takashi YAMAMOTO, Toyota-shi Aichi-ken (JP); Yuka IWANAGA, Toyokawa-shi Aichi-ken (JP); Masayoshi TSUCHINAGA, Nisshin-shi Aichi-ken (JP); Takemitsu MORI, Nisshin-shi Aichi-ken (JP); Kosei TANADA, Toyota-shi Aichi-ken (JP); Masahiro TAKAHASHI, Nagakute-shi Aichi-ken (JP)

(72) Inventors: Takashi YAMAMOTO, Toyota-shi Aichi-ken (JP); Yuka IWANAGA, Toyokawa-shi Aichi-ken (JP); Masayoshi TSUCHINAGA, Nisshin-shi Aichi-ken (JP); Takemitsu MORI, Nisshin-shi Aichi-ken (JP); Kosei TANADA, Toyota-shi Aichi-ken (JP); Masahiro TAKAHASHI, Nagakute-shi Aichi-ken (JP)

(73) Assignees: NAGOYA DENKI EDUCATIONAL FOUNDATION, Nagoya-shi Aichi-ken (JP); TOYOTA JIDOSHA KABUSHIKI KAISHA, Toyota-shi Aichi-ken (JP)

(21) Appl. No.: 18/824,476

(22) Filed: Sep. 4, 2024

(30) Foreign Application Priority Data
Sep. 8, 2023 (JP) 2023-146103

(51) Int. Cl. B25J 9/16; B25J 13/00

(52) U.S. Cl. CPC B25J 9/1664; B25J 13/00

(57) ABSTRACT

A control system, a control method, and a program for causing a robot to perform a plurality of types of operations using handwritten input information are provided. A control system causes a robot to perform an operation based on handwritten input information input to an interface. The control system includes: a handwritten input information reception unit that displays a captured image obtained by capturing an environment in which the robot is located and receives an input of the handwritten input information to the displayed captured image; and a switching unit that switches a plurality of input modes of the handwritten input information for causing the robot to perform different types of operations.

### CROSS REFERENCE TO RELATED APPLICATIONS

This application is based upon and claims the benefit of priority from Japanese patent application No. 2023-146103, filed on Sep. 8, 2023, the disclosure of which is incorporated herein in its entirety by reference.

### BACKGROUND

The present disclosure relates to a control system, a control method, and a program.

Japanese Unexamined Patent Application Publication No. 2021-094605 discloses a remote control system that controls operations performed by a robot based on handwritten input information input to an interface.

### SUMMARY

The operations performed by a robot include a plurality of types of operations, such as an operation for moving the line of sight of the robot, an operation in which the robot moves to a destination, and an operation in which the robot grasps an object to be grasped. It is difficult to determine the type of the operation by using handwritten input information, and hence the convenience of the system may be lessened.

The present disclosure has been made in order to solve the above-described problem and an object thereof is to provide a control system, a control method, and a program that switch input modes of handwritten input information.

A control system according to an embodiment is a control system configured to determine an operation to be performed by a robot based on handwritten input information input to an interface and control the operation performed by the robot, the control system including:
a handwritten input information reception unit configured to receive an input of the handwritten input information; and
a switching unit configured to switch a plurality of input modes of the handwritten input information for causing the robot to perform different types of operations.

The control system may further include a notification unit configured to notify a user who inputs the handwritten input information about a current input mode.

The handwritten input information may include trajectory information of the input performed using a finger, a stylus pen, a pointing device, an Augmented Reality (AR) device, a Virtual Reality (VR) device, or a Mixed Reality (MR) device.

The handwritten input information may be input to a captured image obtained by capturing an environment in which the robot is located, and
the plurality of input modes may include a first mode for changing a direction from which the captured image is captured, a second mode for moving the robot, and a third mode for causing an end effector to perform a grasping operation.

When the captured image does not include an area in which the robot is movable, the switching unit may switch to a mode other than the second mode, and when the end effector is grasping an object to be grasped, the switching unit may switch to a mode other than the third mode.

The switching unit may switch the plurality of input modes in response to a selection operation.

The handwritten input information may be input to a captured image obtained by capturing an environment in which the robot is located, and the switching unit may input the captured image to a learning model and switch to a mode indicated by information output from the learning model.

A control method according to an embodiment is a control method for determining an operation to be performed by a robot based on handwritten input information input to an interface and controlling the operation performed by the robot, the control method including:
receiving an input of the handwritten input information to a captured image; and
switching a plurality of input modes of the handwritten input information for causing the robot to perform different types of operations.

A program according to an embodiment is a program for causing a computer to perform a control method for determining an operation to be performed by a robot based on handwritten input information input to an interface and controlling the operation performed by the robot, the control method including:
receiving an input of the handwritten input information to a captured image; and
switching a plurality of input modes of the handwritten input information for causing the robot to perform different types of operations.

According to the present disclosure, it is possible to provide a control system, a control method, and a program that switch input modes of handwritten input information.

The above and other objects, features and advantages of the present disclosure will become more fully understood from the detailed description given hereinbelow and the accompanying drawings which are given by way of illustration only, and thus are not to be considered as limiting the present disclosure.

### BRIEF DESCRIPTION OF DRAWINGS

FIG. 1 is a conceptual diagram showing an example of an overall environment in which a control system according to a first embodiment is used;

FIG. 2 is a diagram showing an example of handwritten input information;

FIG. 3 is a diagram showing an example of handwritten input information;

FIG. 4 is an external perspective view showing an example of an external configuration of a robot;

FIG. 5 is a block diagram showing an example of a block configuration of the robot;

FIG. 6 is a block diagram showing an example of a block configuration of a remote terminal;

FIG. 7 is a diagram showing an example of a display screen of the remote terminal; and

FIG. 8 is a flowchart showing an example of operations performed by the control system according to the first embodiment.

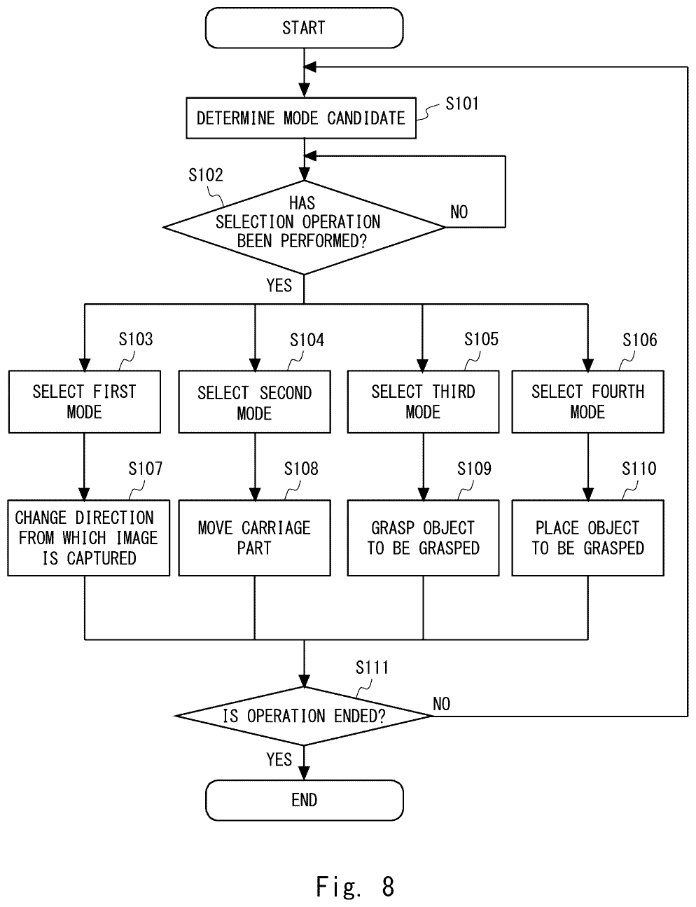

### DESCRIPTION OF EMBODIMENTS

### First Embodiment

The present disclosure will be described hereinafter through embodiments of the disclosure. However, the disclosure according to the claims is not limited to the following embodiments. Further, all the components described in the embodiments are not necessary for solving the problem.

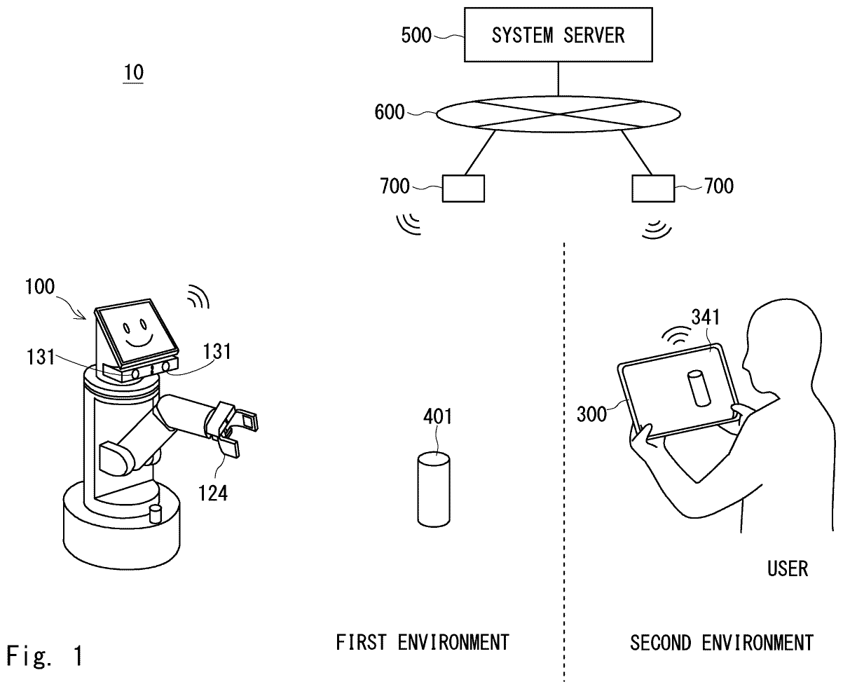

FIG. 1 is a conceptual diagram showing an example of an overall environment in which a control system 10 according to a first embodiment is used. A robot 100 that performs various types of operations in a first environment is remotely controlled via a system server 500 connected to an Internet 600 by allowing a user who is a remote operator present in a second environment distant from the first environment to operate a remote terminal 300 (an operation terminal).

In the first environment, the robot 100 is connected to the Internet 600 via a wireless router 700. Further, in the second environment, the remote terminal 300 is connected to the Internet 600 via the wireless router 700. The robot 100 performs a grasping operation by a hand 124 in accordance with an operation of the remote terminal 300.

The robot 100 captures an image of the first environment in which the robot 100 is located by a stereo camera 131 (an image capturing unit), and transmits the captured image to the remote terminal 300 through the Internet 600. Further, the robot 100 recognizes a graspable object that can be grasped by the hand 124 based on the captured image. In the first environment, for example, an object 401 to be grasped, such as a can, is present. Note that the shape of the object 401 to be grasped is not limited to a cylindrical shape.

The remote terminal 300 is, for example, a tablet terminal, and includes a display panel 341 disposed so that a touch panel is superimposed thereon. The captured image received from the robot 100 is displayed on the display panel 341, and thus a user can visually recognize the first environment in which the robot 100 is located in an indirect manner. Further, a user can input handwritten input information by handwriting to the captured image displayed on the display panel 341. The handwritten input information indicates, for example, rotation of the image capturing unit, a traveling route of the robot 100, an object to be grasped by the hand 124, from which direction the hand 124 grasps the object to be grasped, and the like. As a method for inputting the handwritten input information, for example, a method in which a target part of a captured image is touched using a user's finger, a stylus pen, or the like on a touch panel disposed so as to be superimposed on the display panel 341 may be employed. However, the method therefor is not limited thereto. The handwritten input information may be trajectory information of the input performed using a pointing device such as a mouse. Further, the handwritten input information may be trajectory information of the input performed by a part of a user's body (e.g., a finger), using an Augmented Reality (AR) device, a Virtual Reality (VR) device, or a Mixed Reality (MR) device, which trajectory information is input into a three-dimensional input space.

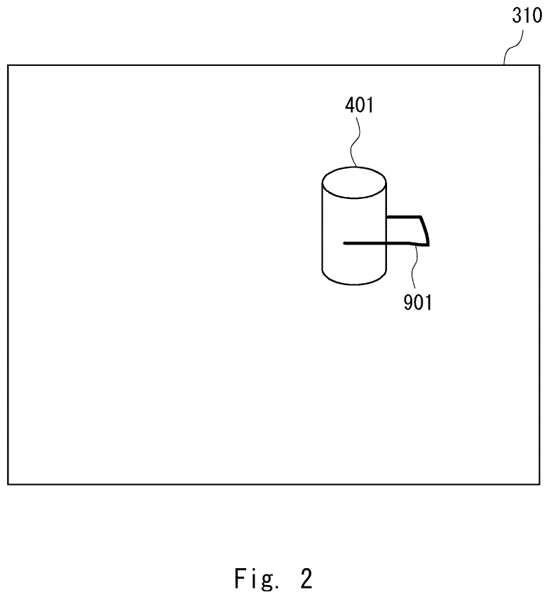

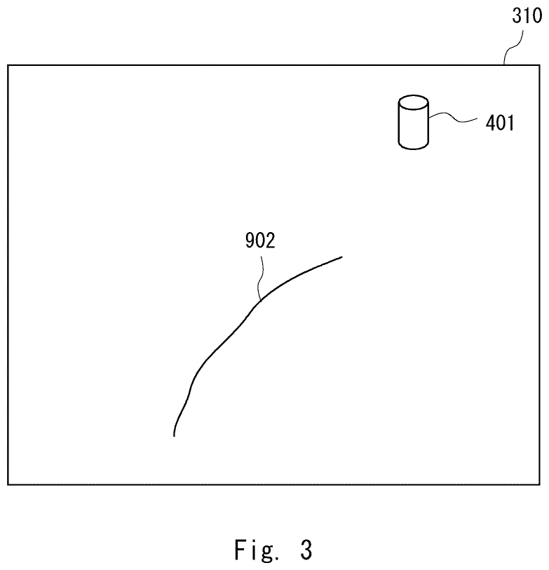

Each of FIGS. 2 and 3 is a diagram showing an example of handwritten input information input to a captured image 310. The example of FIG. 2 shows handwritten input information 901 indicating a simulation in which the object 401 to be grasped is grasped from the side thereof. The example of FIG. 3 shows handwritten input information 902 indicating a simulated traveling route of the robot 100. Further, handwritten input information indicating a simulated rotation of the image capturing unit may be input, although it is not illustrated. For example, when a stylus pen or the like is moved vertically and horizontally on the captured image 310, the line of sight of the image capturing unit moves vertically and horizontally so that it follows the stylus pen or the like. The robot 100 may change its line of sight by rotating the head thereof, or may change its line of sight by turning at a position where the robot 100 is currently located. For example, when the image capturing unit is rotated in the pan direction, the robot 100 may turn at a position where the robot 100 is currently located, while when the image capturing unit is rotated in the tilt direction, the head part of the robot 100 may be inclined. Note that the handwritten input information may include handwritten character information. The handwritten input information input by a user to the captured image is transmitted to the robot 100 through the Internet 600.

The control system 10 switches a plurality of input modes that cause the robot 100 to perform different types of operations. The plurality of input modes may include, for example, a first mode for changing a direction from which the image capturing unit captures an image, a second mode for moving the robot 100, and a third mode for causing the robot 100 to perform a grasping operation.

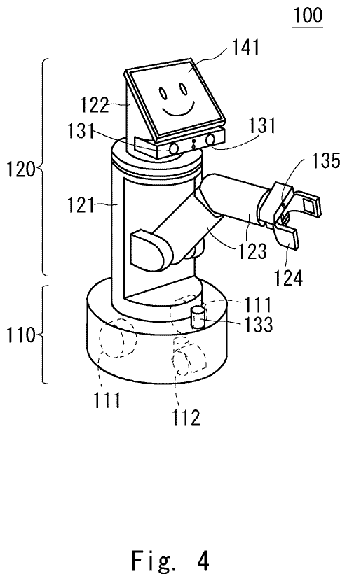

FIG. 4 is an external perspective view showing an example of an external configuration of the robot 100. The robot 100 is mainly formed of a carriage part 110 and a main body part 120. The carriage part 110 supports two driving wheels 111 and a caster 112, each of which is in contact with a traveling surface, inside its cylindrical housing. The two driving wheels 111 are disposed so that the centers of their rotational axes coincide with each other. Each of the driving wheels 111 is rotationally driven by a motor (not shown) independently of each other. The caster 112 is a trailing wheel and is disposed so that its pivotal axis extending from the carriage part 110 in the vertical direction axially supports the wheels at a place some distance from the rotation axes thereof. Further, the caster 112 follows the carriage part 110 so as to move in the moving direction of the carriage part 110.

The carriage part 110 is provided with a laser scanner 133 in a peripheral part of its top surface. The laser scanner 133 scans a certain range on the horizontal plane at intervals of a certain stepping angle and outputs information as to whether or not there is an obstacle in each direction. Further, when there is an obstacle, the laser scanner 133 outputs a distance to the obstacle.

The main body part 120 includes, mainly, a body part 121 mounted on the top surface of the carriage part 110, a head part 122 placed on the top surface of the body part 121, an arm 123 supported on the side surface of the body part 121, and the hand 124 disposed at the tip of the arm 123. The arm 123 and the hand 124 are driven by motors (not shown) and grasp an object to be grasped. The body part 121 is driven by a motor (not shown) and grasps an object to be grasped. The body part 121 can rotate around a vertical axis with respect to the carriage part 110 by a driving force of a motor (not shown).

The head part 122 mainly includes the stereo camera 131 and a display panel 141. The stereo camera 131, which has a configuration in which two camera units having the same angle of view are arranged so as to be space apart from each other, outputs imaging signals of images captured by the respective camera units.

The display panel 141 is, for example, a liquid crystal display panel, and displays an animated face of a preset character and displays information about the robot 100 in the form of text or by using icons. By displaying the face of the character on the display panel 141, it is possible to give an impression that the display panel 141 is a pseudo face part to people present near the robot 100.

The head part 122 can rotate around a vertical axis with respect to the body part 121 by a driving force of a motor (not shown). Thus, the stereo camera 131 can capture an image in any direction. Further, the display panel 141 can show displayed contents in any direction.

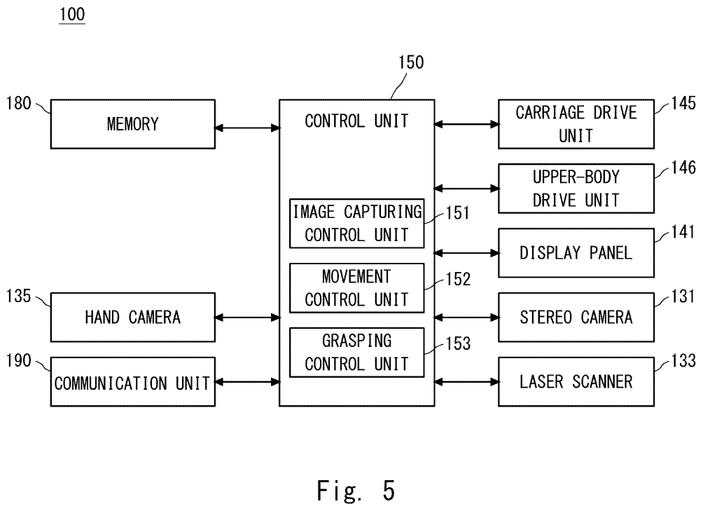

FIG. 5 is a block diagram showing an example of a block configuration of the robot 100. Main elements related to control of operations performed based on handwritten input information will be described below. However, the robot 100 may include in its configuration elements other than the above ones and may include additional elements contributing to the control of operations performed based on handwritten input information.

A control unit 150 is, for example, a central processing unit (CPU), and is housed in, for example, a control box included in the body part 121. A carriage drive unit 145 includes the driving wheels 111, and a driving circuit and motors for driving the driving wheels 111. The control unit 150 performs rotation control of the driving wheels by sending a driving signal to the carriage drive unit 145. Further, the control unit 150 receives a feedback signal such as an encoder signal from the carriage drive unit 145 and recognizes a moving direction and a moving speed of the carriage part 110.

An upper-body drive unit 146 includes the arm 123 and the hand 124, the body part 121, the head part 122, and driving circuits and motors for driving these components. The control unit 150 enables a grasping operation and a gesture by sending a driving signal to the upper-body drive unit 146. Further, the control unit 150 receives a feedback signal such as an encoder signal from the upper-body drive unit 146, and recognizes positions and moving speeds of the arm 123 and the hand 124, and orientations and rotation speeds of the body part 121 and the head part 122.

The display panel 141 receives an image signal generated by the control unit 150 and displays an image thereof. Further, as described above, the control unit 150 may generate an image signal of a character or the like and display an image thereof on the display panel 141.

The stereo camera 131 captures the first environment in which the robot 100 is located in accordance with a request from the control unit 150 and passes an imaging signal to the control unit 150. The control unit 150 performs image processing by using the imaging signal and converts the imaging signal into a captured image in accordance with a predetermined format. The laser scanner 133 detects whether or not there is an obstacle in the moving direction of the robot 100 in accordance with a request from the control unit 150 and passes a detection signal, which is a result of the detection, to the control unit 150.

A hand camera 135 is, for example, a distance image sensor, and is used to recognize a distance to an object to be grasped, a shape of an object to be grasped, a direction in which an object to be grasped is located, and the like. The hand camera 135 includes an image pickup device in which pixels for performing a photoelectrical conversion of an optical image incident from a target space are two-dimensionally arranged, and outputs a distance to a subject to the control unit 150 for each of the pixels. Specifically, the hand camera 135 includes an irradiation unit that irradiates a pattern light to the target space, and receives the reflected light of the pattern light by the image pickup device to output a distance to the subject captured by each of the pixels based on a distortion and a size of the pattern in the image. Note that the control unit 150 recognizes a state of a wider surrounding environment by the stereo camera 131 and recognizes a state in the vicinity of an object to be grasped by the hand camera 135.

A memory 180 is a nonvolatile storage medium. For example, a solid-state drive is used for the memory 180. The memory 180 stores, in addition to a control program for controlling the robot 100, various parameter values, functions, lookup tables, and the like used for the control and the calculation. The memory 180 may store a trained model or the like that uses an image of handwritten input information as an input image and outputs the meaning of a grasping operation simulated by the handwritten input information.

A communication unit 190 is, for example, a wireless LAN unit, and performs radio communication with the wireless router 700. The communication unit 190 receives handwritten input information sent from the remote terminal 300 and passes it to the control unit 150. Further, the communication unit 190 transmits the captured image captured by the stereo camera 131 to the remote terminal 300 in accordance with the control of the control unit 150.

The control unit 150 performs overall control of the robot 100 and various calculation processes by executing a control program read from the memory 180. Further, the control unit 150 also serves as a function execution unit that executes various calculations and controls related to the overall control. As such function execution units, the control unit 150 includes an image capturing control unit 151, a movement control unit 152, and a grasping control unit 153. Further, at least some of the functions of a switching unit 352, which will be described later, may be performed by the control unit 150.

When the input mode is the first mode, the image capturing control unit 151 changes a direction from which the stereo camera 131 captures an image based on handwritten input information. The image capturing control unit 151 may, for example, rotate the carriage part 110 or the head part 122 in the direction in which a stylus pen or a finger is moved.

When the input mode is the second mode, the movement control unit 152 moves the carriage part 110 based on handwritten input information. For example, when handwritten input information includes a linear figure, the movement control unit 152 generates a trajectory passing through points on the line. Then, the movement control unit 152 may send a driving signal to the carriage drive unit 145 so that the carriage part 110 moves along the trajectory.

When the input mode is the third mode, the grasping control unit 153 grasps an object to be grasped based on handwritten input information. The grasping control unit 153, for example, recognizes an object to be grasped included in a captured image using a trained model for recognition, and generates a trajectory of the hand 124 so that the hand 124 grasps the object to be grasped from a direction corresponding to handwritten input information. Then, the grasping control unit 153 may transmit a driving signal corresponding to the generated trajectory to the upper-body drive unit 146.

Further, when the input mode is a fourth mode, the grasping control unit 153 may place an object to be grasped on a table, a floor, or the like based on handwritten input information. For example, the grasping control unit 153 generates a trajectory of the hand 124 so that the hand 124 places an object to be grasped at a position specified by handwritten input information. Then, the grasping control unit 153 may transmit a driving signal corresponding to the generated trajectory to the upper-body drive unit 146.

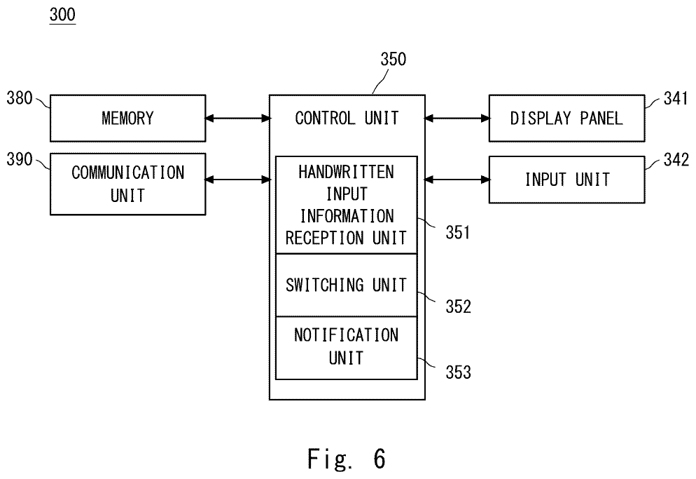

FIG. 6 is a block diagram showing an example of a block configuration of the remote terminal 300. Main elements related to processing for inputting handwritten input information to the captured image received from the robot 100 will be described below. However, the remote terminal 300 may include in its configuration elements other than the above ones and may include additional elements contributing to the processing for inputting handwritten input information.

A control unit 350 is, for example, a central processing unit (CPU) that performs overall control of the remote terminal 300 and various calculation processes by executing a control program read from a memory 380. Further, the control unit 350 also serves as a function execution unit that executes various calculations and controls related to the overall control. As such function execution units, the control unit 350 includes a handwritten input information reception unit 351, the switching unit 352, and a notification unit 353.

The handwritten input information reception unit 351 displays a captured image on the display panel 341 and receives an input of handwritten input information from an input unit 342. Note that the handwritten input information reception unit 351 may receive an input into a three-dimensional space. The captured image may be a three-dimensional image.

The switching unit 352 switches a plurality of input modes for causing the robot 100 to perform different types of operations. The switching unit 352 may switch a plurality of input modes in response to a selection operation. The selection operation may be performed, for example, by a user who operates the remote terminal 300, or by a person who supports the user near the user. The switching unit 352 displays, for example, a button corresponding to each mode on the display panel 141. Then, when an area corresponding to each of the buttons is pressed on the touch panel, the switching unit 352 switches to a mode that corresponds to the button corresponding to the pressed area. Further, the switching unit 352 may select a mode corresponding to voice input from a user.

Further, the switching unit 352 may input a captured image to a trained model and switch to a mode indicated by information output from the trained model. The trained model, for example, is constructed by supervised learning using training data including a captured image and a label indicating an appropriate input mode corresponding to the captured image. For example, when a captured image including an area where the robot 100 can move (e.g., an area where no obstacles is present) is input, the trained model outputs information indicating the second mode. For example, when a captured image including an object to be grasped is input, the trained model outputs information indicating the third mode. For example, when a captured image including only a part of an object to be grasped is input, the trained model may output information indicating the first mode. Further, the switching unit 352 may select one mode by a rule-based method.

The switching unit 352 determines whether or not an area where the robot 100 can move is included in the captured image, and may switch to a mode other than the second mode when the area where the robot 100 can move is not included in the captured image. The robot 100 or the remote terminal 300 may analyze the captured image. The switching unit 352 may, for example, deactivate a button corresponding to the second mode.

The switching unit 352 may determine whether or not the robot 100 is grasping an object to be grasped, and may switch to a mode other than the third mode when the hand 124 of the robot 100 is not grasping the object to be grasped. The switching unit 352 may, for example, receive information indicating whether or not the robot 100 is grasping an object to be grasped from the robot 100, and make the determination based on the received information. The robot 100 may determine whether or not the robot 100 is grasping an object to be grasped based on a result of the detection by a sensor (e.g., a hand camera) provided in the hand 124. The switching unit 352 may deactivate a button corresponding to the third mode.

As described above, the switching unit 352 may be provided in the robot 100 instead of the remote terminal 300. For example, when the input mode is switched using a trained model, the switching unit 352 may be provided in the control unit 150 of the robot 100.

The notification unit 353 notifies a user who operates the remote terminal 300 about the current input mode. The notification unit 353 may display (i.e., output) information (e.g., an icon) indicating the current input mode on the display panel 341, or may output the information by voice from a speaker (not shown). By doing so, a user can confirm the current input mode and then input handwritten input information.

The display panel 341 is, for example, a liquid crystal panel, and displays, for example, a captured image sent from the robot 100.

The input unit 342 includes a touch panel disposed so as to be superimposed on the display panel 141 and a push button provided on a peripheral part of the display panel 141. The input unit 342 passes handwritten input information to the control unit 350. Examples of the handwritten input information are as shown in FIGS. 2 and 3.

The memory 380 is a nonvolatile storage medium. For example, a solid-state drive is used for the memory 380. The memory 380 stores, in addition to a control program for controlling the remote terminal 300, various parameter values, functions, lookup tables, and the like used for the control and the calculation.

A communication unit 390 is, for example, a wireless LAN unit, and performs radio communication with the wireless router 700. The communication unit 390 receives a captured image sent from the robot 100 and passes it to the control unit 350. Further, the communication unit 390 cooperates with the control unit 350 to transmit handwritten input information to the robot 100.

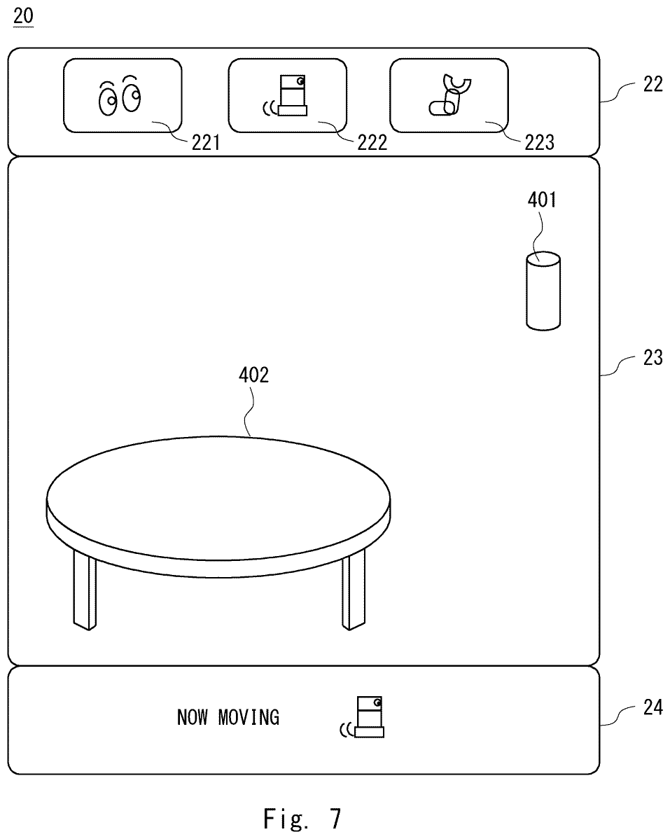

FIG. 7 is an explanatory diagram showing an example of a display screen displayed on the display panel 341. A display screen 20 illustrated in FIG. 7 includes a mode selection button 22, a viewer 23, and a command button 24.

The mode selection button 22 includes a button 221 corresponding to the first mode, a button 222 corresponding to the second mode, and a button 223 corresponding to the third mode. The mode selection button may further include a button (not shown) corresponding to the fourth mode. For example, when the button 222 has been selected, the button 222 may be displayed in a form (e.g., color) different from those of the buttons 221 and 223. An image captured by the stereo camera 131 is displayed on the viewer 23. The captured image may include, for example, the object 401 to be grasped and an obstacle 402. Information indicating the mode currently being executed is displayed in the command button 24. For example, when the second mode has been selected, the words “now moving” or an animation indicating movement of the robot 100 is displayed. The notification unit 353 can notify a user about the current mode by the command button 24 or the like.

Next, an example of operations performed by the control system 10 according to the first embodiment will be described. First, the switching unit 352 of the control unit 350 of the remote terminal 300 determines whether or not an area where the robot 100 can move is included in a captured image and determines whether or not the hand 124 of the robot 100 is grasping an object to be grasped, thereby determining a mode candidate in accordance with a result of the determination (Step S101). When an area where the robot 100 can move is not included in the captured image, the switching unit 352 sets a mode other than the second mode as the mode candidate. When the hand 124 is grasping the object to be grasped, the switching unit 352 sets a mode other than the third mode as the mode candidate. When an area where the robot 100 can move is not included in the captured image and the hand 124 is grasping the object to be grasped, the switching unit 352 sets a mode other than the second mode and the third mode as the mode candidate. The switching unit 352 activates a button corresponding to the mode candidate and deactivates a button corresponding to a mode other than the mode candidate.

Next, the control unit 350 determines whether or not a selection operation has been performed (Step S102). When a selection operation has not been performed (NO in Step S102), the process returns to Step S102.

When a selection operation has been performed (YES in Step S102), the switching unit 352 of the control unit 350 switches to the first mode (Step S103), switches to the second mode (Step S104), switches to the third mode (Step S105), or switches to the fourth mode (Step S106) in accordance with the selection operation.

When switching to the first mode is performed, the control unit 350 receives an instruction that the direction from which the stereo camera 131 captures an image is to be changed in accordance with handwritten input information, and the image capturing control unit 151 of the robot 100 changes the direction from which the stereo camera 131 captures an image in accordance with the above instruction (Step S107).

When switching to the second mode is performed, the control unit 350 receives an instruction that the carriage part 110 is to be moved in accordance with handwritten input information, and the movement control unit 152 of the robot 100 moves the carriage part 110 in accordance with the above instruction (Step S108).

When switching to the third mode is performed, the control unit 350 receives an instruction that an object to be grasped is to be grasped in accordance with handwritten input information, and the grasping control unit 153 of the robot 100 grasps the object to be grasped in accordance with the above instruction (Step S109).

When switching to the fourth mode is performed, the control unit 350 receives an instruction that an object to be grasped is to be placed in accordance with handwritten input information, and the grasping control unit 153 of the robot 100 places the object to be grasped in a position specified by the above instruction (Step S110).

Then, the control system 10 determines whether or not to end the remote control (Step S111). When the remote control is not ended (NO in Step S111), the process returns to Step S101, while when the remote control is ended (YES in Step S111), the process is ended.

Note that steps for switching input modes using a trained model or the like may be provided in place of Steps S101 to S106.

Next, an effect obtained by the control system 10 according to the first embodiment will be described. Operations performed by a robot include changing the line of sight and moving a carriage in addition to operating an object, and a combination of these operations achieves a meaningful task. However, in the related art, there is a problem that, with regard to certain handwritten input information, it is not possible to determine whether or not it is an instruction related to an operation of an object or an instruction related to movement of a carriage. In a system that receives free inputs as handwritten input characters (e.g., lines), it is particularly important how the meaning of the input handwritten input information is interpreted when a robot performs a wide variety of complex tasks.

The control system 10 according to the first embodiment is configured to switch input modes of handwritten input information. Therefore, it is easy to interpret handwritten input characters, and thus the convenience of the system can be improved.

Note that the present disclosure is not limited to the above-described embodiments and may be changed as appropriate without departing from the scope and spirit of the present disclosure. In the above embodiments, the robot 100 and the remote terminal 300 exchange captured images and handwritten input information through the Internet 600 and the system server 500. However, the present disclosure is not limited thereto. The robot 100 and the remote terminal 300 may exchange captured images and handwritten input information by direct communication.

Further, in the above embodiments, the case in which a plurality of input modes are the first mode to the third mode or the first mode to the fourth mode has been described. However, the present disclosure is not limited thereto. The plurality of modes may include any mode other than the first mode to the fourth mode. Further, the plurality of input modes may not include some or all of the first mode to the fourth mode.

Further, in the above embodiments, the stereo camera 131 is used. However, the present disclosure is not limited thereto. The robot 100 may include any image capturing unit provided at any place in the first environment. The image capturing unit is not limited to a stereo camera and may be a monocular camera or the like.

Further, in the above embodiments, an example in which the robot 100 includes the hand 124 at the tip of the arm 123 as an end effector has been described. However, the present disclosure is not limited thereto. The robot 100 may be any robot including an end effector and performing a grasping operation by using the end effector. Further, the end effector may be a grasping part (e.g., a suction part) other than a hand.

The program includes instructions (or software codes) that, when loaded into a computer, cause the computer to perform one or more of the functions described in the embodiments. The program may be stored in a non-transitory computer readable medium or a tangible storage medium. By way of example, and not a limitation, non-transitory computer readable media or tangible storage media can include a random-access memory (RAM), a read-only memory (ROM), a flash memory, a solid-state drive (SSD) or other types of memory technologies, a CD-ROM, a digital versatile disc (DVD), a Blu-ray (Registered Trademark) disc or other types of optical disc storage, a magnetic cassette, a magnetic tape, and a magnetic disk storage or other types of magnetic storage devices. The program may be transmitted on a transitory computer readable medium or a communication medium. By way of example, and not a limitation, transitory computer readable media or communication media can include electrical, optical, acoustical, or other forms of propagated signals.

From the disclosure thus described, it will be obvious that the embodiments of the disclosure may be varied in many ways. Such variations are not to be regarded as a departure from the spirit and scope of the disclosure, and all such modifications as would be obvious to one skilled in the art are intended for inclusion within the scope of the following claims.

What is claimed is:

1. A control system configured to determine an operation to be performed by a robot based on handwritten input information input to an interface and control the operation performed by the robot, the control system comprising:
a handwritten input information reception unit configured to receive an input of the handwritten input information; and
a switching unit configured to switch a plurality of input modes of the handwritten input information for causing the robot to perform different types of operations.

2. The control system according to claim 1, further comprising a notification unit configured to notify a user who inputs the handwritten input information about a current input mode.

3. The control system according to claim 1, wherein the handwritten input information includes trajectory information of the input performed using a finger, a stylus pen, a pointing device, an Augmented Reality (AR) device, a Virtual Reality (VR) device, or a Mixed Reality (MR) device.

4. The control system according to claim 1, wherein
the handwritten input information is input to a captured image obtained by capturing an environment in which the robot is located, and
the plurality of input modes include a first mode for changing a direction from which the captured image is captured, a second mode for moving the robot, and a third mode for causing an end effector to perform a grasping operation.

5. The control system according to claim 4, wherein when the captured image does not include an area in which the robot is movable, the switching unit switches to a mode other than the second mode, and when the end effector is grasping an object to be grasped, the switching unit switches to a mode other than the third mode.

6. The control system according to claim 1, wherein the switching unit switches the plurality of input modes in response to a selection operation.

7. The control system according to claim 1, wherein
the handwritten input information is input to a captured image obtained by capturing an environment in which the robot is located, and
the switching unit inputs the captured image to a learning model and switches to a mode indicated by information output from the learning model.

8. A control method for determining an operation to be performed by a robot based on handwritten input information input to an interface and controlling the operation performed by the robot, the control method comprising:
receiving an input of the handwritten input information to a captured image; and
switching a plurality of input modes of the handwritten input information for causing the robot to perform different types of operations.

9. A non-transitory computer readable medium storing a program for causing a computer to perform a control method for determining an operation to be performed by a robot based on handwritten input information input to an interface and controlling the operation performed by the robot, the control method comprising:
receiving an input of the handwritten input information to a captured image; and
switching a plurality of input modes of the handwritten input information for causing the robot to perform different types of operations.
